(19) United States
(12) Patent Application Publication
(10) Pub. No.: US 2025/0173635 A1
(43) Pub. Date: May 29, 2025

(54) ENTERPRISE RESOURCE PLANNING SYSTEM WITH MANAGEMENT OF AUTOMATICALLY DEPLOYED DATA

(71) Applicant: SAP SE, Walldorf (DE)

(72) Inventors: Wulf Kruempelmann, Altlussheim (DE); Thomas Vogt, Roemerberg (DE); Dominik Ofenloch, Lampertheim (DE); Susanne Schott, ‘Walldorf (DE)

(21) Appl. No.: 18/521,376

(22) Filed: Nov. 28, 2023

(51) Int. Cl. G06Q 10/0631

(52) U.S. Cl. CPC G06Q 10/0631

(57) ABSTRACT

Various examples are directed to systems and methods for enterprise resource planning ERP. A customer environment may execute an ERP software application. A DBMS executing at the first customer environment may store a first basis data table comprising a first plurality of basis data units of a first basis data unit type. The DBMS may receive, from the ERP software application, a basis data request for a basis data unit of the first basis data unit type and determine that the basis data unit that is not stored at the first basis data table. The DBMS may access basis data unit from a basis data service system.

### BACKGROUND

A database management system (DBMS) can be implemented as part of a suite of software applications that execute together. For example, the DBMS may support various client processes that utilize the DBMS to manage data. In some examples, a DBMS is implemented with a suite of processes that implement an enterprise resource planning (ERP) software solution. An ERP software solution may include one or more ERP applications. The ERP applications execute in conjunction with the DBMS to manage various different aspects of business operations. An example ERP software solution is the S/4 HANA product available from SAP SE of Walldorf, Germany.

The ERP application generates and utilizes the data stored at the DBMS to perform different enterprise operations. For example, an ERP application supporting a human resources operation may store employee records at the DBMS. The human resources ERP application may perform various tasks such as, for example, managing payroll, benefits, and the like. An example ERP application supporting accounting may use records managed by the DBMS to perform various accounting-related tasks such as generating and recording invoices, accounts payable, and the like. An ERP application supporting operations may manage and generate various purchase orders, shipping orders, and/or the like to manage manufacturing or other operations.

### BRIEF DESCRIPTION OF DRAWINGS

The present disclosure is illustrated by way of example and not limitation in the following figures.

FIG. 1 is a diagram showing one example of an environment including example customer environments and a basis data service system.

FIG. 2 is a flowchart showing one example of a process flow that may be executed at the customer environment of FIG. 1 to manage basis data.

FIG. 3 is a flowchart showing one example of a process flow that may be implemented in the customer environment of FIG. 1 to manage basis data.

FIG. 4 is a flowchart showing one example of a process flow that may be executed by the basis data batch process of FIG. 1 to report basis usage data to the basis data service system.

FIG. 5 is a flowchart showing one example of a process flow that may be executed by the basis data service system of FIG. 1 to generate basis data to be provided to a customer environment.

FIG. 6 is a flowchart showing one example of a process flow that may be executed by the basis data service system of FIG. 1 to train the computerized model 164.

FIG. 7 is a block diagram showing one example of an architecture for a computing device.

FIG. 8 is a block diagram of a machine in the example form of a computer system within which instructions may be executed for causing the machine to perform any one or more of the methodologies discussed herein.

### DETAILED DESCRIPTION

Enterprise Resource Planning (ERP) software applications commonly use basis data during execution. Basis data includes data that is the basis of other processing, such as business configurations utilized by various ERP software applications. Examples of basis data can include data describing address formats in different countries of the world, data describing different units of measure, data describing different currencies and exchange rates, and/or the like.

Consider an example ERP software application that handles financial or accounting tasks such as generating accounts payable, invoices, and/or the like. While such accounts payable, invoices, and/or the like may be generated from enterprise-specific financial data, they may also utilize basis data. For example, an accounts payable or invoice may be mailed to a business partner. The ERP software application may access and utilize a basis data unit describing the address format in the country of the business partner. The ERP software application may also access and utilize basis data describing units of measure, for example, to express a quantity or quantities of items that are the subject of the invoice or account payable.

Consider another example ERP software application that handles human resources. Such an ERP software application may also utilize basis data describing address formats in different countries for example, to express the home addresses of enterprise employees, the addresses of the employees' financial institutions, and/or the like. Basis data describing currencies and exchange rates may also be utilized to express employee salaries, benefits, and/or the like.

Consider another example ERP software application that handles operations for a manufacturing enterprise. Such an ERP application may utilize basis data describing units of measure for raw materials that are used in various processing steps.

In some examples, basis data is provided by the developer of a database management system (DBMS) and/or associated ERP software solution and deployed to a customer environment along with the DBMS and/or associated ERP software solution. For example, basis data may be deployed to one or more basis data tables managed by the DBMS using storage at the customer environment. Units of basis data may be stored as records at the basis data table or tables.

It is desirable for the developer of a DBMS and/or associated ERP software solution to provide and deploy basis data that will be used by its customers. Accordingly, developers may wish to provide a DBMS and/or associated ERP software solution with a large set of basis data to cover the needs of different customer enterprises in different fields and different geographic locations. This may lead to additional challenges. For example, deploying a large set of basis data to a customer environment may involve consuming a large quantity of data storage at the customer environment. Also, higher quantities of deployed basis data may increase the processing resources used to query the basis data. Additionally, a large cache of deployed basis data may complicate the process of updating or upgrading the DBMS and/or associated ERP software applications.

These challenges may be accentuated because different customers may utilize different basis data units. For example, a full set of basis data of a type indicating address formats may include 193 basis data units, with each basis data unit indicating the address format for a different country. Not all customers, however, will utilize address formats for all 193 countries. For example, customers that do not have operations in a particular region of the globe may not utilize basis data units indicating address formats for countries in that region. Other customers doing business in the particular region of the globe may regularly utilize the corresponding basis data units. Consider another example regarding units of measure. A customer that operates a chemical manufacturing enterprise may utilize basis data units corresponding to units of measure such as, for example, Angstrom or mol per liter, whereas other customers may not. Further, the mix of basis data units utilized by customers, or even by a particular customer, may not be readily apparent from the identity of a customer or even from the attributes of the customer.

Various examples address these and other challenges utilizing various elements including, for example, a schema structure and trigger at the DBMS and/or a basis data service system remote from the customer environment. In some examples, the DBMS may be arranged with a schema structure including one or more basis data tables and one or more basis data usage tables. A basis data usage table may have a key structure similar or identical to a corresponding basis data table or tables. For example, the basis data usage table may comprise records corresponding to the records at the basis data tables. For example, a basis data unit may be stored at a record of a basis data table. There may also be a record corresponding to the same basis data unit at a basis data usage table.

The DBMS may implement a trigger configured to execute after database operations directed to one or more of the basis data tables. The database operation directed to one or more of the basis tables may request one or more basis data units. When executed, the trigger may write usage data describing the use of the requested basis data units to a basis data usage table or tables. The usage data may be or include a tally of the number of select operations directed to a particular basis data unit. As a result, the basis data usage table may comprise usage data indicating the usage of basis data at a given customer environment.

In some examples, the customer environment may also execute a batch job. The batch job may execute at the DBMS to select usage data from the basis data usage table or tables and transfer the usage data to a corresponding basis data usage table or tables at a basis data service system, that may be remote from the customer environment. The basis data service system may periodically execute a trained computerized model. The trained computerized model may receive input corresponding to basis data usage at one or more customer environments. The output of the trained computerized model may indicate a subset of basis data that is to be pre-deployed to customer environments.

In some examples, the DBMS and/or ERP software applications are deployed with a reduced set of basis data. When an ERP software application, or the DBMS itself, selects a basis data unit that is not deployed the DBMS may be configured to query the basis data service system to obtain the requested basis data unit. The basis data unit, retrieved from the basis data service system, may then be used by the DBMS and/or ERP software application. In some examples, if the DBMS requests the same basis data unit more than a threshold number of times, it may write the received to a basis data table. For subsequent selects of the basis data unit, the DBMS may retrieve the basis data unit from the basis data table, which may obviate the need to query the basis data service system.

In some examples, the described arrangements of the DBMS, ERP application(s) may utilize a reduced set of basis data at the customer environment without excessive reductions in the performance of the ERP application(s). For example, utilizing a reduced set of basis data at the customer environment may reduce the storage and CPU requirements at the customer environment. Using the basis data service system to select the reduced set of basis data based on basis usage data received from one or more customer environments may result in selections of basis data that are based on usage.

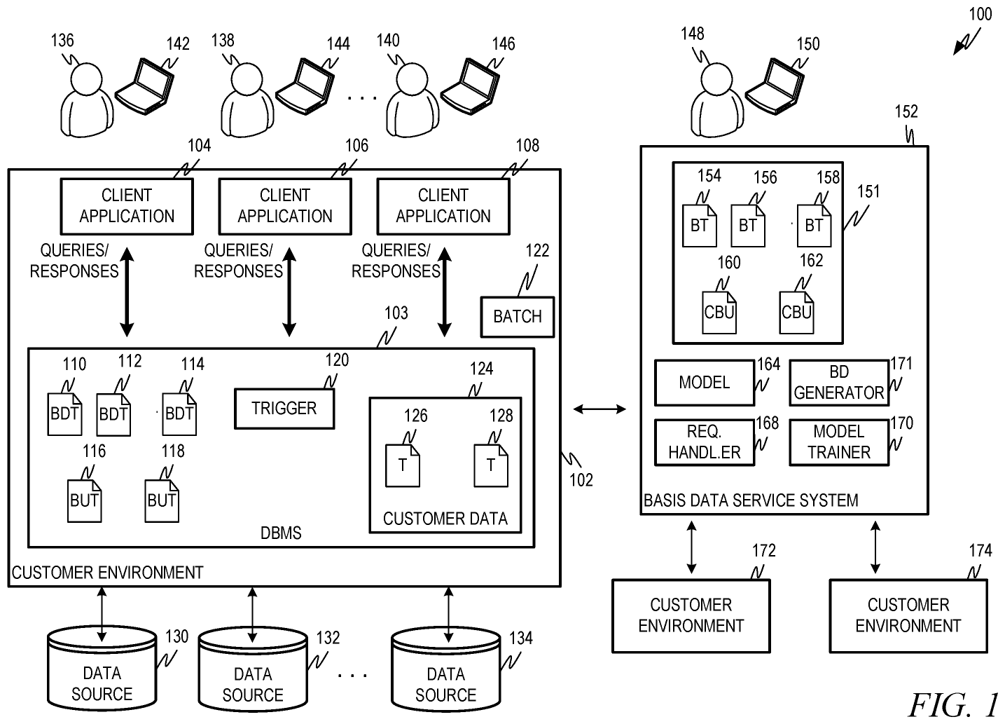

FIG. 1 is a diagram showing one example of an environment 100 including example customer environments 102, 172, 174 and a basis data service system 152. The customer environments 102, 172, 174 may be arranged to implement ERP solutions comprising respective DBMSs, such as DBMS 103, and one or more client applications, such as client applications 104, 106, 108. The respective customer environments 102 may be configured, for example, as described herein, to communicate with the basis data service system 152 to manage basis data at the customer environments 102, 172, 174. The ERP solutions installed at the respective customer environments 102, 172, 174, in conjunction with the basis data service system 152, may provide improved management of basis data deployed to the customer environments 102, 172, 174.

The environment 100 includes users 136, 138, 140 who may access the customer environment 102 with user computing devices 142, 144, 146. User computing devices 142, 144, 146 may be and/or include various different types of computing devices such as, for example, desktop computers, laptop computers, tablet computers, mobile computing devices, and/or the like. Users 136, 138, 140 may be associated with a customer enterprise that is implementing an ERP solution including the DBMS 103 and client applications 104, 106, 108. The users may utilize and/or configure the client applications 104, 106, 108 to perform various ERP related tasks, for example, as described herein. The client applications 104, 106, 108 may perform ERP related tasks, for example, based on basis data and customer enterprise-specific customer data 124 managed by the DBMS 103.

The customer environment 102 may be or include various different arrangements of servers or other computing devices to execute respective DBMSs and client applications. In some examples, the customer environment 102 may be or include an on-premise environment. An on-premise environment comprises one or more computing systems maintained by the customer enterprise utilizing the ERP solution. For example, a developer may provide the customer enterprise with executable code to implement the DBMS 103 and/or client applications 104, 106, 108 at the on-premise environment. In addition to executable code, the developer may provide the customer enterprise with deployed basis data, which may be stored by the DBMS 103 as described herein. Users 136, 138, 140 associated with the customer enterprise may access client applications 104, 106, 108 executing, for example, at the on-premise computing system. Users 136, 138, 140 may access the on-premise computing system remotely via user computing devices 142, 144, 146, and/or directly via input/output components of the on-premise computing system such as, for example, a keyboard and/or a monitor.

In some examples, the customer environment 102 may be or include a private cloud environment. In a private cloud environment, a cloud service provider gives access to computing hardware such as servers, data storage, and/or the like. The customer enterprise provides software in data that is executed and stored at the private cloud environment. For example, in a private cloud implementation, the developer of the ERP solution may provide the customer enterprise and/or the private cloud environment with executable code, basis data, and/or the like for implementing the ERP solution. The customer enterprise may cause the executable code and/or basis data to be deployed to the private cloud environment. Users 136, 138, 140 associated with the customer enterprise may access the ERP solution at the private cloud environment.

In some examples, the customer environment 102 may be or include a public cloud environment. A public cloud environment includes one or more servers or other computing hardware. The public cloud environment may be arranged into a number of tenancies implemented by a cloud service provider. Each tenancy may be associated with a customer enterprise and accessible by users 136, 138, 140 associated with that customer enterprise. The cloud service provider may provide one or more executables, basis data, and/or other components to implement the ERP solution, including the DBMS 103 and client applications 104, 106, 108 at the public cloud environment. Users 136, 138, 140 associated with a customer enterprise holding a tenancy at the public cloud environment may access the ERP solution by accessing their associated tenancy at the public cloud environment.

The customer environment 102 may also include one or more data sources 130, 132, 134. In some examples, data sources 130, 132, 134 may provide persistent data storage for basis data and customer data 124 stored by the DBMS 103. It will be appreciated that, in some examples, the DBMS 103 may be or include an in-memory database, such as the HANA system from SAP SE of Walldorf, Germany. An in-memory database may store basis data and customer data 124 at a main memory, such as a random access memory, of the customer environment 102. The data may be persisted at one or more data sources 130, 132, 134.

The data sources 130, 132, 134 may be implemented at the customer environment 102 and/or at one or more cloud-implemented data sources. Examples of cloud-delivered data source services may include cloud versions of S/4 HANA™, SAP Concur®, SAP Successfactors®, SAP Data Warehouse Cloud, Inbound Document (IBD), available from SAP SE of Walldorf, Germany. Other examples of cloud-delivered data sources may include SQL database services such as, for example, BigQuery® available from Google, LLC of Mountain View, California, Sharepoint® available from Microsoft Corporation of Redmond, Washington, various data storage products available from Salesforce, Inc. of San Francisco, California, and/or the like.

The DBMS 103 manages the storage of customer data 124 for implementing the ERP solution. For example, the customer data 124 may include financial data, human resources data, operations data, and/or other data utilized by the client applications 104, 106, 108 and/or DBMS 103 to perform various ERP tasks, for example, as described herein. Customer data 124 may be arranged in various customer data tables 126, 128. The customer data tables 126, 128 may be arranged into any suitable schema.

The DBMS 103 may manage the storage of basis data at one or more basis data tables 110, 112, 114. In some examples, different basis data tables 110, 112, 114 store different types of basis data. For example, basis data describing address formats in different countries may be stored at a corresponding basis data table 110, 112, 114. Also, basis data units describing units of measure may be stored at a corresponding basis data table 110, 112, 114.

Basis data tables 110, 112, 114 may be arranged such that records at the various basis data tables 110, 112, 114 correspond to individual basis data units. For example, a basis data table 110, 112, 114 for storing basis data units describing address formats in different countries may comprise a first record, where columns of the record include the address formats in a first country. Columns of a second record may include address records in a second country, and so on. Records of the basis data tables 110, 112, 114 may be associated with unique keys. Accordingly, each unit of basis data stored at a basis data table 110, 112, 114 may be described by a unique key. In some examples, keys for basis data units are unique across all basis data tables 110, 112, 114.

The DBMS 103 may configured to execute a basis data trigger 120. The basis data trigger 120 is executable code that is executed in response to a specified operation at the DBMS 103. In some examples, the basis data trigger 120 is implemented as part of code implementing DBMS 103. In various examples, the basis data trigger 120 is configured to execute in response to a select operation or other database operation that accesses one or more records of the basis data tables 110, 112, 114.

When executed, the basis data trigger 120 may store basis usage data to one or more basis usage tables 116, 118. Basis usage data may describe usage of basis data units at the customer environment 102. In some examples, usage data includes a tally of a number of times that different basis data units have been utilized in the customer environment 102. In some examples, the basis usage tables 116, 118 have a key structure parallel to that of the basis data tables 110, 112, 114. For example, records at the basis usage tables 116, 118 may comprise keys corresponding to keys describing basis data units at the basis data tables 110, 112, 114. Although two basis usage tables 116, 118 are shown in FIG. 1, it will be appreciated that various embodiments may include different numbers of basis usage tables 116, 118. In some examples, each basis data table 110, 112, 114 may have a corresponding basis usage table 116, 118 storing basis usage data corresponding to basis data units stored at the respective basis data table 110, 112, 114. For example, the basis data table 110 may have a corresponding basis usage table; the basis data table 112 may have a corresponding basis usage table; and so on. Also, in some examples, there may be fewer basis usage tables 116, 118 than there are basis data tables 110, 112, 114. In some examples, there is a single basis usage table that includes basis usage data describing all basis data units managed by the DBMS 103.

The customer environment 102 may also execute a basis data batch process 122. The basis data batch process 122 may comprise executable code that is executed in the customer environment 102 to perform the functions of the basis data batch process 122 described herein. In some examples, the basis data batch process 122 is implemented as a portion of the code implementing the DBMS 103.

The basis data batch process 122 may execute periodically. For example, the basis data batch process 122 may execute once per hour, once per 12 hours, once per 24 hours, once per 48 hours, once per 72 hours, once per week, and/or the like. When it executes, the basis data batch process 122 may retrieve basis usage data from the one or more basis usage tables 116, 118 and transferred the basis usage data to the basis data service system 152.

It will be appreciated that the customer environment 172, 174 may be arranged in a manner similar to that of the customer environment 102. For example, customer environments 172, 174 may implement ERP software solutions for respective customer enterprises. Users of the respective customer enterprises (not shown in FIG. 1) may access the ERP software solutions executed at the respective customer environments 172, 174. The customer environments 172, 174 may also implement respective DBMSs and client applications, similar to that of the customer environment 102.

The basis data service system 152 may be implemented, for example, by the developer of the ERP software solution, to provide basis data services to the customer environments 102, 172, 174. The basis data service system 152 may be implemented in an on premise, private cloud, and/or public cloud arrangement. The basis data service system 152 may be remote from the respective customer environments 102, 172, 174. This may include arrangements in which the basis data service system 152 is implemented at different computing hardware than the respective customer environments 102, 172, 174. In some examples, this may include arrangements in which the basis data service system 152 is implemented by a common cloud provider, but in a distinct private cloud environment and/or public cloud tenancy from one or more of the customer environments 102, 172, 174.

The basis data service system 152 may be accessible by one or more users 148 utilizing one or more user computing devices 150. For example, the user 148 may be an administrative user accessing the basis data service system 152 to configure one or more aspects of the basis data service system 152.

The basis data service system 152 may comprise a request handler service 168, a computerized model 164, and a model trainer service 170. The basis data service system 152 may also store basis data 151. In some examples, the basis data service system 152 may implement a DBMS for storing the basis data 151. The request handler service 168 may comprise executable code that is executed at the basis data service system 152 to handle messages and requests received from the customer environments 102, 172, 174. In some examples, the customer environments 102, 172, 174 may send requests for basis data units. For example, as described herein, a customer environment (the DBMS 103 thereof) may store a subset of available basis data. When a client applications 104, 106, 108 or the DBMS 103 itself requests a basis data unit that is not stored at the DBMS 103, the DBMS 103 or other suitable component at the customer environment 102 may query the basis data service system 152. The request handler service 168 may receive the query and respond by providing a requested basis data unit or units.

The basis data service system 152 may store basis data at one or more basis data tables 154, 156, 158. In some examples, basis data tables 154, 156, 158 may parallel basis tables 110, 112, 114 stored at the customer environment 102. For example, each basis data table 154, 156, 158 may include basis data units of different types. In contrast to the basis data tables 110, 112, 114, the basis data tables 154, 156, 158 may comprise a super set of basis data units, including basis data units that are not automatically deployed to the customer environments 102, 172, 174. In some examples, the request handler service 168 may query the basis data tables 154, 156, 158 retrieve basis data units requested by the respective customer environments 102, 172, 174.

In some examples, the request handler service 168 may also respond to basis data usage messages received, for example, from the basis data batch process 122. For example, the request handler service 168 may store basis usage data received from various customer environments 102, 172, 174 at one or more central basis usage data tables 160, 162. In some examples, the basis usage tables 160, 162 may parallel the basis usage tables 116, 118 at the customer environment 102. For example, the basis usage tables 160, 162 may have a key structure that is similar to that of the basis data tables 110, 112, 114, 154, 156, 158. In some examples, the central basis usage tables may comprise a number of records identified uniquely by keys corresponding to the keys used to describe basis data units at the basis data tables 154, 156, 158. Records at the central basis usage tables 160, 162 may indicate a tally of how many times a particular basis data unit was requested at a customer environment 102, 172, 174. In some examples, records at the central basis usage tables 160, 162 may also indicate identities of the customer environments 102, 172, 174 and a corresponding tally of the number of times that a particular basis data unit was requested by that particular customer environment 102, 172, 174.

The computerized model 164 may be any computerized model that is arranged to receive input including customer attribute data describing a customer enterprise associated with one or more customer environments 102, 172, 174. The output of the output model 164 describes a set of one or more basis data units that should be deployed to the customer.

The computerized model 164 may be of any suitable form including, for example, a classification model, such as a logistic regression model, a naive Bayes model, a K-nearest neighbors model, a decision tree model, a random forest model, a support vector machine (SVM) model, a Convolutional Neural Network (CNN), a Recurrent Neural Networks (RNN) such as a Long-Short-Term Model (LSTMs), Gated Recurrent Unit (GRU) models or any other sort of RNN. Also, in some examples, other types of computerized models may be used such as, for example, other types of neural networks. The computerized model 164 may be implemented in various different ways. In some examples, the computerized model 164 is implemented as a callable function. Also, in some examples, the computerized model 164 is implemented as separate executable code that can execute at the basis data service system 152.

The basis data service system 152 may also implement a model trainer service 170. The model trainer service 170 may be or include executable code that may execute at the basis data service system 152 to train the computerized model 164. For example, the model trainer service 170 may generate model training data from the central basis usage data stored at the central basis usage data tables 160, 162. Generating the training data may comprise labeling usage data describing various basis data units. The labels, for example, may include customer attribute data describing one or more customers associated with customer environments 102, 172, 174 that have requested or otherwise used the respective basis data units. The model trainer service 170 may utilize the resulting labeled training data to train the computerized model 164.

The bias data service system 152 may also comprise a basis data generator service 171. The basis generator service may be or include executable code that may be executed at the basis data service system to generate sets of basis data to be deployed to one or more of the customer environments 102, 172, 174. In some examples, the bias data service system 152 may utilize an output of the computerized model 164 to generate sets of basis data units that are to be deployed to customer environments 102, 172, 174 associated with customers having a particular set of customer attributes. For example, a customer that is described by attributes indicating that the customer operates a chemical manufacturing operation may receive a set of basis data units that are likely to be utilized in the context of the chemical manufacturing operation. Also, for example, a customer having attributes indicating that the customer has business operations in Europe may receive a set of basis data units including address formats for European countries.

In some examples, the basis data generator service 171 may create data containers associated with specific customer environments 102, 172, 174 and/or with customer environments 102, 172, 174 associated with customer enterprises described by a set or range of attributes. Data containers associated with a specific customer environment 102, 172, 174 or customer enterprise may include a set of basis data units that are likely to be used by that customer environment 102, 172, 174 or specific customer enterprise. The basis data generator service 171, in some examples, may push one or more data containers to a particular customer environment 102, 174, 172 or environments.

In some examples, the basis data generator service 171 may be configured to make modifications to pre-deployed basis data at one or more of the customer environments 102, 172, 174. For example, the basis data generator service 171 may determine that some or all customer environments 102, 172, 174 are requesting a particular basis data unit or units above a threshold level. This may be performed by examining central basis usage data at central basis usage data tables 160, 162 and/or by utilizing an output of the computerized model 164. When basis data generator service 171 determines that some or all of the customer environments 102, 172, 174 are requesting a particular basis data unit or units above the threshold, then the basis data generator service 171 may push that basis data unit or units to some or all of the customer environments 102, 172, 174.

Also, in some examples, the basis data generator service 171 may determine that a basis data unit or units that was initially deployed to one or more of the customer environments 102, 172, 174 is used at the customer environments 102, 172, 174 below a threshold level. This may be performed by examining central basis usage data at central basis usage data tables 160, 162 and/or by utilizing an output of the computerized model 164. When basis data generator service 171 determines that some or all of the customer environments 102, 172, 174 are using a particular basis data unit or units below the threshold, in some examples, the basis data generator service 171 may send a message to the respective customer environment or environments 102, 172, 174 instructing the customer environment to delete the basis data unit or units.

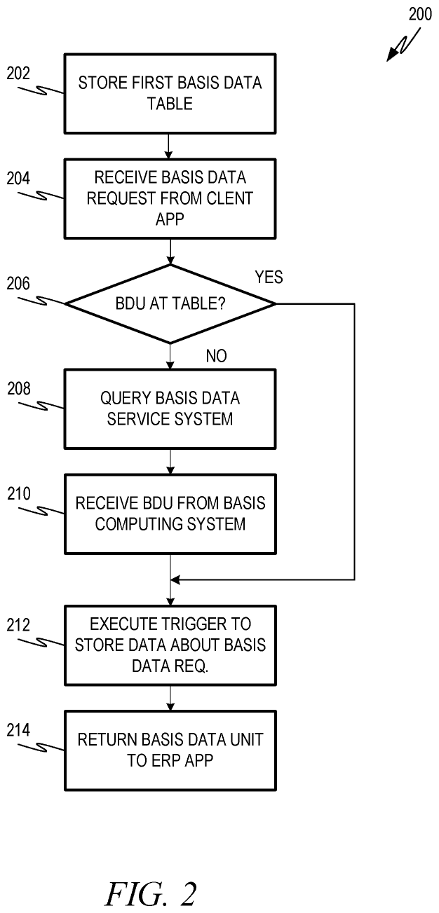

FIG. 2 is a flowchart showing one example of a process flow 200 that may be executed at the customer environment 102 to manage basis data. In some examples, the process flow 200 is performed by the DBMS 103. At operation 202, the DBMS 103 may store a first basis data table comprising basis data units. Operation 202 may be performed, for example, when an ERP solution comprising the DBMS 103 and various client applications one of four, 106, 108 is deployed to the customer environment 102. In some examples, the operation 202 may be performed after deployment, for example, upon receiving one or more additional basis data units from the basis data service system 152.

At operation 204, the DBMS 103 receives a basis data request from a client applications 104, 106, 108. The basis data request may be a standalone request and/or may be associated with another query or request to the DBMS 103 that utilizes basis data. For example, the basis data request may comprise and/or be associated with a request to generate customer data 124 that depends on basis data. Consider an example query or request to generate a data structure associated with an invoice. Such a query or request may utilize basis data describing address formats, units of measure and/or the like.

At operation 206, the DBMS 103 determines if the basis data unit or units for responding to the request from the client applications are stored at one or more of the basis data tables 110, 112, 114. If one or more basis data units for responding to the request are not stored at the basis data tables 110, 112, 114, then the DBMS 103 may, at operation 208, query the basis data service system 152 for the missing basis data unit or units. In response to the query, the basis data service system 152 (e.g. the request handler service 168 thereof), may send the requested basis data unit or units. The DBMS 103 may receive the requested basis data unit at operation 210.

After receiving a basis data unit or units from the basis data service system 152 at operation 210, or after determining that the requested basis data unit or units are stored at a basis data table 110, 112, 114, the DBMS 103 may execute the basis data trigger 120 at operation 212. The basis data trigger 120 may store an indication of the requested basis data units at one or more of the basis usage tables 116, 118. For example, the basis data trigger 120 may identify, for each basis data unit, a record at one of the basis usage tables 116,118. The identified record for a basis data unit may have a key corresponding to the key identifying the basis data unit at its corresponding basis data table 110, 112, 114. The basis data trigger 120 may increment a field at the corresponding record to indicate that the basis data unit was requested. At operation 214, the DBMS 103 may return the requested basis data unit or units to the requesting client applications 104, 106, 108.

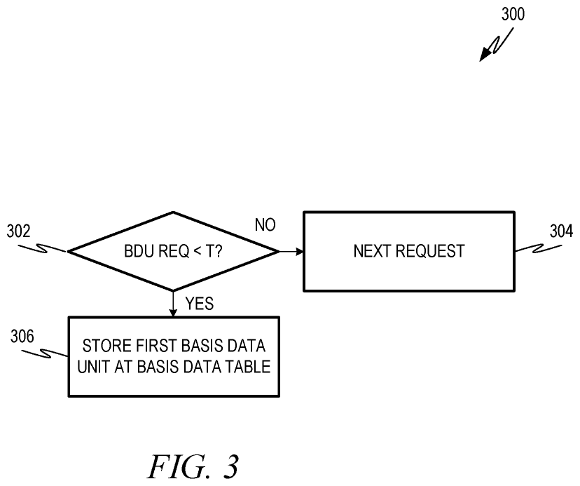

FIG. 3 is a flowchart showing one example of a process flow 300 that may be implemented in the customer environment 102 to manage basis data. For example, the process flow 300 may be implemented by the DBMS 103. In some examples, the process flow 300 may be executed by the DBMS 103 when the DBMS 103 makes a request to the basis data service system 152 for a basis data unit or units that are not stored at the DBMS 103.

At operation 302, the DBMS 103 may determine if a request to the basis data service system 152 for a basis data unit raises the number of requests to the basis data service system 152 for that basis data unit above a threshold. If the number of requests for the basis data unit is not above the threshold, then the DBMS 103 may, at operation 304, wait for its next request from the client applications 104, 106, 108. If the number of requests for the basis data unit is above the threshold, then the DBMS 103 may, at operation 306, store the basis data unit received from the basis data service system 152 to a basis data table 110, 112, 114. In this way, the DBMS 103 may not need to retrieve the basis data unit from the basis data service system 15 to the next time that it is requested by one or more of the client applications 104, 106, 108.

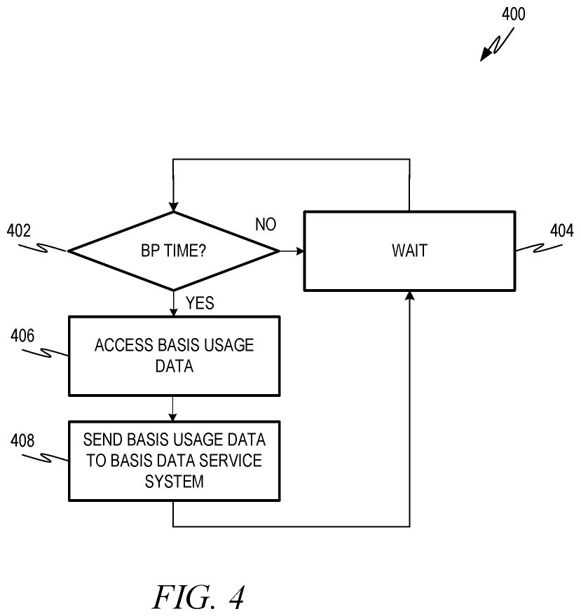

FIG. 4 is a flowchart showing one example of a process flow 400 that may be executed, for example, by the basis data batch process 122 to report basis usage data to the basis data service system 152. At operation 402, the basis data batch process 122 may determine if it is time to execute. For example, the basis data batch process 122 may execute once per period. Determining if it is time for the basis data batch process 122 to execute may include determining if the period has elapsed since the previous time that the basis data batch process 122 executed. If it is not time for the basis data batch process 122 to execute, then the basis data batch process 122 may wait operation 404 and then return to operation 402.

When the basis data batch process 122 determines that it is time to execute, it may, at operation 406, access basis usage data stored at one or more basis usage data tables 116, 118. At operation 408, the basis data batch process 122 may send the accessed basis usage data to the basis data service system, for example, for storage at central basis usage tables 160, 162.

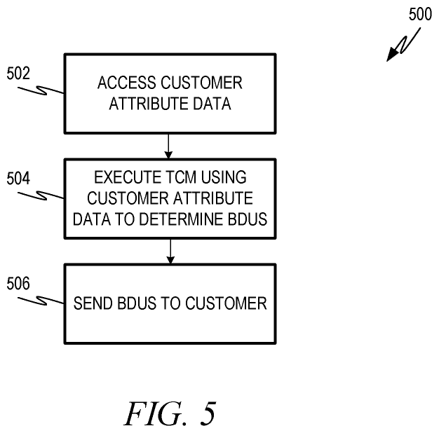

FIG. 5 is a flowchart showing one example of a process flow 500 that may be executed by the basis data service system 152, such as, for example the basis data generator service 171 thereof, to generate basis data to be provided to a customer environment 102 172, 174. At operation 502, the basis data service system 152 accesses customer attribute data. The customer attribute data includes attributes of a customer enterprise associated with one or more customer environments 102, 172, 174.

At operation 504, the basis data service system 152 executes the trained computerized model 164 with the customer attribute data as input. The output of the trained computerized model 164 may indicate one or more basis data units stored at basis data tables 154, 156, 158. At operation 506, the basis data service system 152 may provide the indicated basis data units to the customer environments 102, 172, 174 associated with the customer attribute data. In some examples, the process flow 500 may be executed at an initial deployment of an ERP software solution to a customer environment 102, 172, 174. Also, in some examples, the process flow 500 may be executed after an ERP software solution has been deployed to a customer environment 102, 172, 174, for example, to supplement the basis data units stored at the customer environment 102, 172, 174, for example, by sending a revised set of basis data units. Also, in some examples, the basis data service system 152 may utilize the output of the trained computerized model 164 to instruct the customer environment 102, 172, 174 to delete one or more basis data units that are not indicated by the trained computerized model 164 and, therefore, are not likely to be used at the customer environment 102, 172, 174.

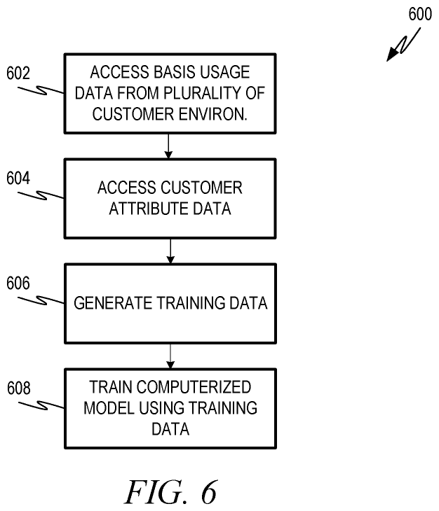

FIG. 6 is a flowchart showing one example of a process flow 600 that may be executed by the basis data service system 152 (e.g., the model trainer service 170 thereof) to train the computerized model 164. At operation 602, the model trainer service 170 may access basis usage data from a plurality of customer environments 102, 172, 174. This may include accessing one or more of the central basis usage data stored at central basis usage tables 160, 162. As described herein, the central basis usage data may indicate a tally of the number of times that various basis data units are used in association with indications of the customer environment 102, 172, 174 associated with the uses of the basis data units. At operation 604, the model trainer service 170 may access customer attributes describing a customer environment 102, 172, 174 and/or a customer enterprise associated with one or more of the customer environments 102, 172, 174.

At operation 606, the model trainer service 170 may generate training data. This may include labeling the basis usage data with the customer attribute data accessed at operation 604. This may provide labeled training data describing the usage of basis data at the various customer environments 102, 172, 174 associated with the particular usage. At operation 608, the model trainer service 170 may train the computerized model 164 using the training data generated at operation 606. The model trainer service 170 may train the computerized model 164 using any suitable technique over any suitable number of epochs. For example, at each epoch, the model trainer service may be configured to apply a gradient descent technique to a loss function describing a difference between the result of the computerized model 164 at the epoch and the label(s) of the corresponding training data.

### EXAMPLES

Example 1 is a system for enterprise resource planning (ERP), comprising: at least one hardware processor programmed to perform operations comprising: executing, at a first customer environment, an ERP software application; storing, at a first database management system executing at the first customer environment, a first basis data table comprising a first plurality of basis data units of a first basis data unit type; receiving, by the first database management system and from the ERP software application, a basis data request for a basis data unit of the first basis data unit type; determining, by the first database management system, that the basis data unit that is not stored at the first basis data table; accessing, by the first database management system, the basis data unit from a basis data service system that is remote from the first customer environment; executing, by the first database management system, a basis data trigger associated with the first basis data table, the executing of the basis data trigger comprising writing, to a first basis data trigger table at the first database management system, a description of the basis data request; and executing a basis data batch process, the executing of basis data batch process comprising sending first basis usage data to the basis data service system, the first basis usage data comprising the description of the basis data request.

In Example 2, the subject matter of Example 1 optionally includes the first customer environment being at least one of a cloud environment or an on-premise environment.

In Example 3, the subject matter of any one or more of Examples 1-2 optionally includes the operations further comprising: determining, by the first database management system, that the basis data unit has been requested more than a threshold number of times; and storing the basis data unit at the first basis data table.

In Example 4, the subject matter of any one or more of Examples 1-3 optionally includes the operations further comprising: accessing, by the basis data service system, first customer attribute data describing a first customer associated with the first customer environment; using, by the basis data service system, the first customer attribute data to execute a trained computerized model to generate a revised first plurality of the basis data units for the first customer; and sending, by the basis data service system, the revised first plurality of the basis data units for the first customer to the first database management system.

In Example 5, the subject matter of Example 4 optionally includes the operations further comprising: accessing, by the basis data service system, second customer attribute data describing a second customer associated with a second customer environment; using, by the basis data service system, the second customer attribute data to execute the trained computerized model to generate a second plurality of basis data units of the first basis data unit type for the second customer; and sending, by the basis data service system, the second plurality of basis data units to a second database management system executing at the second customer environment.

In Example 6, the subject matter of Example 5 optionally includes the operations further comprising: sending, by the basis data service system, the second plurality of basis data units to the second database management system; and sending, by the basis data service system, basis data unit type.

In Example 7, the subject matter of any one or more of Examples 4-6 optionally includes the operations further comprising: accessing, by the basis data service system, customer attribute data describing a plurality of customers; accessing basis usage data from the plurality of customers, the basis usage data describing usage of basis data by the plurality of customers; using the customer attribute data and basis usage data to generate training data for training the trained computerized model; and training the trained computerized model using the training data.

In Example 8, the subject matter of any one or more of Examples 1-7 optionally includes the operations further comprising storing, at the first database management system, a second basis data table comprising basis data unit type.

Example 9 is a method for enterprise resource planning using a first database management system deployed to a first customer environment, the method comprising: executing, at the first customer environment, an ERP software application; storing, at the first database management system, a first basis data table comprising a first plurality of basis data units of a first basis data unit type; receiving, by the first database management system and from the ERP software application, a basis data request for a basis data unit of the first basis data unit type; determining, by the first database management system, that the basis data unit that is not stored at the first basis data table; accessing, by the first database management system, the basis data unit from a basis data service system that is remote from the first customer environment; executing, by the first database management system, a basis data trigger associated with the first basis data table, the executing of the basis data trigger comprising writing, to a first basis data trigger table at the first database management system, a description of the basis data request; and executing a basis data batch process, the executing of basis data batch process comprising sending first basis usage data to the basis data service system, the first basis usage data comprising the description of the basis data request.

In Example 10, the subject matter of Example 9 optionally includes the first customer environment being at least one of a cloud environment or an on-premise environment.

In Example 11, the subject matter of any one or more of Examples 9-10 optionally includes determining, by the first database management system, that the basis data unit has been requested more than a threshold number of times; and storing the basis data unit at the first basis data table.

In Example 12, the subject matter of any one or more of Examples 9-11 optionally includes accessing, by the basis data service system, first customer attribute data describing a first customer associated with the first customer environment; using, by the basis data service system, the first customer attribute data to execute a trained computerized model to generate a revised first plurality of the basis data units for the first customer; and sending, by the basis data service system, the revised first plurality of the basis data units for the first customer to the first database management system.

In Example 13, the subject matter of Example 12 optionally includes accessing, by the basis data service system, second customer attribute data describing a second customer associated with a second customer environment; using, by the basis data service system, the second customer attribute data to execute the trained computerized model to generate a second plurality of basis data units of the first basis data unit type for the second customer; and sending, by the basis data service system, the second plurality of basis data units to a second database management system executing at the second customer environment.

In Example 14, the subject matter of Example 13 optionally includes sending, by the basis data service system, the second plurality of basis data units to the second database management system; and sending, by the basis data service system, basis data unit type.

In Example 15, the subject matter of any one or more of Examples 12-14 optionally includes accessing, by the basis data service system, customer attribute data describing a plurality of customers; accessing basis usage data from the plurality of customers, the basis usage data describing usage of basis data by the plurality of customers; using the customer attribute data and basis usage data to generate training data for training the trained computerized model; and training the trained computerized model using the training data.

In Example 16, the subject matter of Example 15 optionally includes storing, at the first database management system, a second basis data table comprising basis data unit type.

Example 17 is a non-transitory machine-readable medium comprising instructions thereon that, when executed by at least one hardware processor, because the at least one hardware processor to perform operations comprising: at least one hardware processor programmed to perform operations comprising: executing, at a first customer environment, an enterprise resource planning (ERP) software application; storing, at a first database management system executing at the first customer environment, a first basis data table comprising a first plurality of basis data units of a first basis data unit type; receiving, by the first database management system and from the ERP software application, a basis data request for a basis data unit of the first basis data unit type; determining, by the first database management system, that the basis data unit that is not stored at the first basis data table; accessing, by the first database management system, the basis data unit from a basis data service system that is remote from the first customer environment; executing, by the first database management system, a basis data trigger associated with the first basis data table, the executing of the basis data trigger comprising writing, to a first basis data trigger table at the first database management system, a description of the basis data request; and executing a basis data batch process, the executing of basis data batch process comprising sending first basis usage data to the basis data service system, the first basis usage data comprising the description of the basis data request.

In Example 18, the subject matter of Example 17 optionally includes the first customer environment being at least one of a cloud environment or an on-premise environment.

In Example 19, the subject matter of any one or more of Examples 17-18 optionally includes the operations further comprising: determining, by the first database management system, that the basis data unit has been requested more than a threshold number of times; and storing the basis data unit at the first basis data table.

In Example 20, the subject matter of any one or more of Examples 17-19 optionally includes the operations further comprising: accessing, by the basis data service system, first customer attribute data describing a first customer associated with the first customer environment; using, by the basis data service system, the first customer attribute data to execute a trained computerized model to generate a revised first plurality of the basis data units for the first customer; and sending, by the basis data service system, the revised first plurality of the basis data units for the first customer to the first database management system.

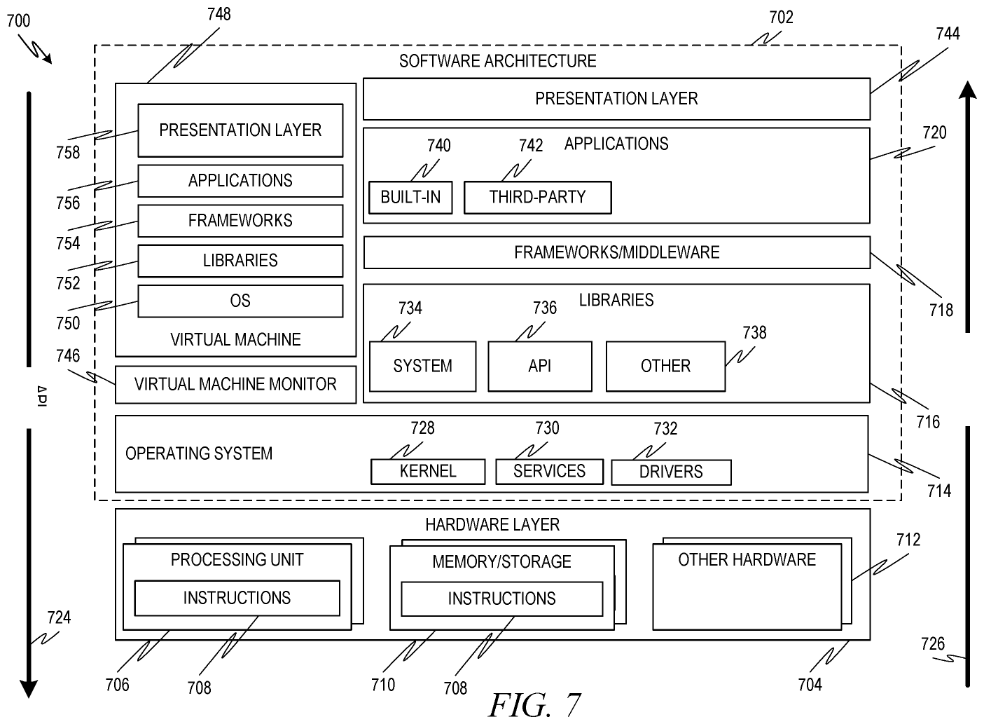

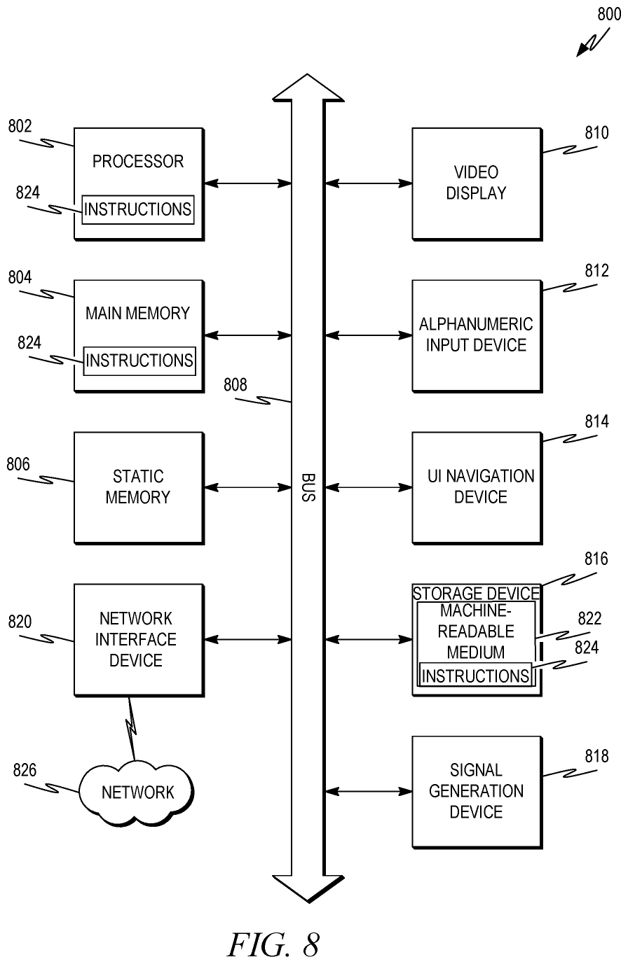

FIG. 7 is a block diagram 700 showing one example of a software architecture 702 for a computing device. The architecture 702 may be used in conjunction with various hardware architectures, for example, as described herein. FIG. 7 is merely a non-limiting example of a software architecture and many other architectures may be implemented to facilitate the functionality described herein. A representative hardware layer 704 is illustrated and can represent, for example, any of the above referenced computing devices. In some examples, the hardware layer 704 may be implemented according to the architecture of the computer system of FIG. 8.

The representative hardware layer 704 comprises one or more processing units 706 having associated executable instructions 708. Executable instructions 708 represent the executable instructions of the software architecture 702, including implementation of the methods, modules, subsystems, and components, and so forth described herein and may also include memory and/or storage modules 710, which also have executable instructions 708. Hardware layer 704 may also comprise other hardware as indicated by other hardware 712 which represents any other hardware of the hardware layer 704, such as the other hardware illustrated as part of the architecture 702.

In the example architecture of FIG. 7, the software architecture 702 may be conceptualized as a stack of layers where each layer provides particular functionality. For example, the software architecture 702 may include layers such as an operating system 714, libraries 716, middleware layer 718, applications 720, and presentation layer 744. Operationally, the applications 720 and/or other components within the layers may invoke API calls 724 through the software stack and access a response, returned values, and so forth illustrated as messages 726 in response to the API calls 724. The layers illustrated are representative in nature and not all software architectures have all layers. For example, some mobile and/or special purpose operating systems may not provide a middleware layer 718, while others may provide such a layer. Other software architectures may include additional and/or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the architecture 702 to pause its current processing and execute an interrupt service routine (ISR) when an interrupt is accessed.

The drivers 732 may be responsible for controlling and/or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 716 may include system 734 libraries (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The middleware layer 718 (also sometimes referred to as frameworks) may provide a higher-level common infrastructure that may be utilized by the applications 720 and/or other software components/modules. For example, the middleware layer 718 may provide various graphic user interface (GUI) functions, high-level resource management, high-level location services, and so forth. The middleware layer 718 may provide a broad spectrum of other APIs that may be utilized by the applications 720 and/or other software components/modules, some of which may be specific to a particular operating system and/or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any of the built-in applications 740 as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 742 may invoke the API calls 724 provided by the mobile operating system such as operating system 714 to facilitate functionality described herein.

The applications 720 may utilize built-in operating system functions (e.g., kernel 728, services 730 and/or drivers 732), libraries (e.g., system 734, API libraries 736, and other libraries 738), and middleware layer 718 to create user interfaces to interact with users of the system. Alternatively, or additionally, in some systems interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine as well as the interface with the host operating system (i.e., operating system 714). A software architecture executes within the virtual machine such as an operating system 750, libraries 752, frameworks/middleware 754, applications 756 and/or presentation layer 758. These layers of software architecture executing within the virtual machine 748 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 8 is a block diagram of a machine in the example form of a computer system 800 within which instructions 824 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804, and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface navigation (or cursor control) device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, with the main memory 804 and the processor 802 also constituting machine-readable media 822.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system for enterprise resource planning (ERP), comprising:
at least one hardware processor programmed to perform operations comprising:
executing, at a first customer environment, an ERP software application;
storing, at a first database management system executing at the first customer environment, a first basis data table comprising a first plurality of basis data units of a first basis data unit type;
receiving, by the first database management system and from the ERP software application, a basis data request for a basis data unit of the first basis data unit type;
determining, by the first database management system, that the basis data unit that is not stored at the first basis data table;
accessing, by the first database management system, the basis data unit from a basis data service system that is remote from the first customer environment;
executing, by the first database management system, a basis data trigger associated with the first basis data table, the executing of the basis data trigger comprising writing, to a first basis data trigger table at the first database management system, a description of the basis data request; and
executing a basis data batch process, the executing of basis data batch process comprising sending first basis usage data to the basis data service system, the first basis usage data comprising the description of the basis data request.

2. The system of claim 1, the first customer environment being at least one of a cloud environment or an on-premise environment.

3. The system of claim 1, the operations further comprising:
determining, by the first database management system, that the basis data unit has been requested more than a threshold number of times; and
storing the basis data unit at the first basis data table.

4. The system of claim 1, the operations further comprising:
accessing, by the basis data service system, first customer attribute data describing a first customer associated with the first customer environment;
using, by the basis data service system, the first customer attribute data to execute a trained computerized model to generate a revised first plurality of the basis data units for the first customer; and
sending, by the basis data service system, the revised first plurality of the basis data units for the first customer to the first database management system.

5. The system of claim 4, the operations further comprising:
accessing, by the basis data service system, second customer attribute data describing a second customer associated with a second customer environment;
using, by the basis data service system, the second customer attribute data to execute the trained computerized model to generate a second plurality of basis data units of the first basis data unit type for the second customer; and
sending, by the basis data service system, the second plurality of basis data units to a second database management system executing at the second customer environment.

6. The system of claim 5, the operations further comprising:
sending, by the basis data service system, the second plurality of basis data units to the second database management system; and
sending, by the basis data service system, basis data unit type.

7. The system of claim 4, the operations further comprising:
accessing, by the basis data service system, customer attribute data describing a plurality of customers;
accessing basis usage data from the plurality of customers, the basis usage data describing usage of basis data by the plurality of customers;
using the customer attribute data and basis usage data to generate training data for training the trained computerized model; and
training the trained computerized model using the training data.

8. The system of claim 1, the operations further comprising storing, at the first database management system, a second basis data table comprising basis data unit type.

9. A method for enterprise resource planning using a first database management system deployed to a first customer environment, the method comprising:
executing, at the first customer environment, an ERP software application;
storing, at the first database management system, a first basis data table comprising a first plurality of basis data units of a first basis data unit type;
receiving, by the first database management system and from the ERP software application, a basis data request for a basis data unit of the first basis data unit type;
determining, by the first database management system, that the basis data unit that is not stored at the first basis data table;
accessing, by the first database management system, the basis data unit from a basis data service system that is remote from the first customer environment;
executing, by the first database management system, a basis data trigger associated with the first basis data table, the executing of the basis data trigger comprising writing, to a first basis data trigger table at the first database management system, a description of the basis data request; and
executing a basis data batch process, the executing of basis data batch process comprising sending first basis usage data to the basis data service system, the first basis usage data comprising the description of the basis data request.

10. The method of claim 9, the first customer environment being at least one of a cloud environment or an on-premise environment.

11. The method of claim 9, further comprising:
determining, by the first database management system, that the basis data unit has been requested more than a threshold number of times; and
storing the basis data unit at the first basis data table.

12. The method of claim 9, further comprising:
accessing, by the basis data service system, first customer attribute data describing a first customer associated with the first customer environment;
using, by the basis data service system, the first customer attribute data to execute a trained computerized model to generate a revised first plurality of the basis data units for the first customer; and
sending, by the basis data service system, the revised first plurality of the basis data units for the first customer to the first database management system.

13. The method of claim 12, further comprising:
accessing, by the basis data service system, second customer attribute data describing a second customer associated with a second customer environment;
using, by the basis data service system, the second customer attribute data to execute the trained computerized model to generate a second plurality of basis data units of the first basis data unit type for the second customer; and
sending, by the basis data service system, the second plurality of basis data units to a second database management system executing at the second customer environment.

14. The method of claim 13, further comprising:
sending, by the basis data service system, the second plurality of basis data units to the second database management system; and
sending, by the basis data service system, basis data unit type.

15. The method of claim 12, further comprising:
accessing, by the basis data service system, customer attribute data describing a plurality of customers;
accessing basis usage data from the plurality of customers, the basis usage data describing usage of basis data by the plurality of customers;
using the customer attribute data and basis usage data to generate training data for training the trained computerized model; and
training the trained computerized model using the training data.

16. The method of claim 15, further comprising storing, at the first database management system, a second basis data table comprising basis data unit type.

17. A non-transitory machine-readable medium comprising instructions thereon that, when executed by at least one hardware processor, because the at least one hardware processor to perform operations comprising:
at least one hardware processor programmed to perform operations comprising:
executing, at a first customer environment, an enterprise resource planning (ERP) software application;
storing, at a first database management system executing at the first customer environment, a first basis data table comprising a first plurality of basis data units of a first basis data unit type;
receiving, by the first database management system and from the ERP software application, a basis data request for a basis data unit of the first basis data unit type;
determining, by the first database management system, that the basis data unit that is not stored at the first basis data table;
accessing, by the first database management system, the basis data unit from a basis data service system that is remote from the first customer environment;
executing, by the first database management system, a basis data trigger associated with the first basis data table, the executing of the basis data trigger comprising writing, to a first basis data trigger table at the first database management system, a description of the basis data request; and
executing a basis data batch process, the executing of basis data batch process comprising sending first basis usage data to the basis data service system, the first basis usage data comprising the description of the basis data request.

18. The non-transitory machine-readable medium of claim 17, the first customer environment being at least one of a cloud environment or an on-premise environment.

19. The non-transitory machine-readable medium of claim 17, the operations further comprising:
determining, by the first database management system, that the basis data unit has been requested more than a threshold number of times; and
storing the basis data unit at the first basis data table.

20. The non-transitory machine-readable medium of claim 17, the operations further comprising:
accessing, by the basis data service system, first customer attribute data describing a first customer associated with the first customer environment;
using, by the basis data service system, the first customer attribute data to execute a trained computerized model to generate a revised first plurality of the basis data units for the first customer; and
sending, by the basis data service system, the revised first plurality of the basis data units for the first customer to the first database management system.
